(19) United States
(12) Patent Application Publication
(10) Pub. No.: US 2009/0285229 A1
(43) Pub. Date: Nov. 19, 2009

(54) METHOD FOR SCHEDULING OF PACKETS IN TDMA CHANNELS

(76) Inventors: Michal Wermuth, Haifa (IL); Chen Ben Avner, Haifa (IL)

Correspondence Address: YORAM TSIVION, P.O. BOX 1307, PARDES HANNA, 37111, IL

(21) Appl. No.: 12/304,781

(22) PCT Filed: Jun. 15, 2007
(86) PCT No.: PCT/IB07/52287

§ 371 Date: Dec. 15, 2008

(30) Foreign Application Priority Data
Jun. 15, 2006 (IL) 176332

(51) Int. Cl. H04L 12/56

(52) U.S. Cl. 370/412

(57) ABSTRACT

The method of the invention is implemented in ad hoc communications network employing at least two-hop routing and wherein each node in the network employs an omnidirectional send/receive capability. Each node keeps a near neighbour database (NND) updated by receiving of messages. Each Othernode in the network, the message of which was received by Mynode in a time period T, is a candidate for becoming a relay for transmitting Mynode's messages. The probability of an Othernode to become a relay for Mynode is higher for a larger amount of candidates Othernode has in its NND. The probability for the Othernode to become a relay is higher the larger its distance from Mynode.

### FIELD OF THE INVENTION

The present invention is in the field of packet scheduling in communications and computer networks. More specifically, the invention is a method for scheduling packets from different queues in a node to a time slotted channel, whereby quality of service for each queue is considered with respect to quality of service of other queues.

### BACKGROUND OF THE INVENTION

Packet switched networks use multiplexing methods to send packets from intermediate nodes that receive packets belonging to various flows. Packets from various incoming flows can be interleaved in a node and sent via the same link. Congestion occurs when multiple flows feed into a single node, and the node cannot continue injecting the packets to the link at the desired rate. This can result in dropped packets and failed QoS (quality of service) implementation. Managing queues is a basic strategy used to overcome such situations. To implement this, separate queues are usually provided, such that each QoS option is allocated a specific queue. Typically the node has few queues from different QoS for the outgoing link. An arriving packet is sent to specific queue on the way to the next node. To schematically describe the queuing management in a node reference is made to FIG. 1. Packet 38 is a packet reaching the node from flow B, multiplexed with packet 40 from flow N, multiplexed with packet 42 from flow R and multiplexed with packet 44 of flow C. In the node, the packets are classified by packet classifier 46. Subsequently, the classified packets are assigned to respective queues, flow N and flow B packets with the same class priority are assigned to queue 48, flow R packets are assigned to queue 50 and flow C packets to queue 52. Packet scheduler 64 schedules the packets from each queue according to a prioritization scheme, into communications channel 68.

The effect of a scheduling discipline is to decide, based on a calculation, which queue is to be served in the next round of transmission. The general processor sharing discipline (GPS) is described by A. K. Parekh and R. G. Gallager in “A Generalized Processor Sharing approach to Flow control in Integrated Services Networks: The Single Node Case.” Proceedings of IEEE Infocom 1992, the contents of which are incorporated herein by reference. The GPS is a theoretical approach assuming infinitesimal packet sizes but there are several real world approximations to this discipline. The weighted round robin (WRR) is a scheduling discipline that considered a simple emulation of the GPS discipline. It suffers from a major drawback since it requires that the packets' size be constant. Such a requirement does not suit many communications environments. To overcome this problem, the deficit round robin (DRR) was developed M. Shreedhar and G. Varghese, “Efficient fair queuing using deficit round robin,” Proc. of ACM SIGCOMM '95, August 1995, pp. 231-242, the contents of which are incorporated herein by reference. In priority queuing discipline, described by Andrew S. Tanenbaum, Prentice Hall, 2^{nd} Edition, 2001, each packet is associated with a specific priority value of the respective queue. The scheduling discipline addresses the fairness of the service, increase in usage of communications channels. Fairness of a scheduling discipline is the adherence to the QoS rules, relating to each queue to be served.

### BRIEF DESCRIPTION OF THE DRAWINGS

FIG. 1 is a schematic description of prior art queue management in a node using separate queues for different flows in a node;

FIG. 2 is a schematic description of queue management in accordance with the present invention, emphasizing the place of the packet fragmenter;

FIG. 3A is a schematic description of a symbolic time slot sequence and populating direction along a slotted communications channels;

FIG. 3B is a schematic description of a symbolic slot sequence and different packet distribution order in two slots;

FIG. 3C is a schematic description of a symbolic slot sequence and ordered packet distribution spanning two slots

FIG. 3D is a schematic description of a symbolic slot sequence showing each fragment encapsulated with overhead.

FIG. 3E is a schematic description of a symbolic slot sequence showing fragment of same packet populated in the same slot.

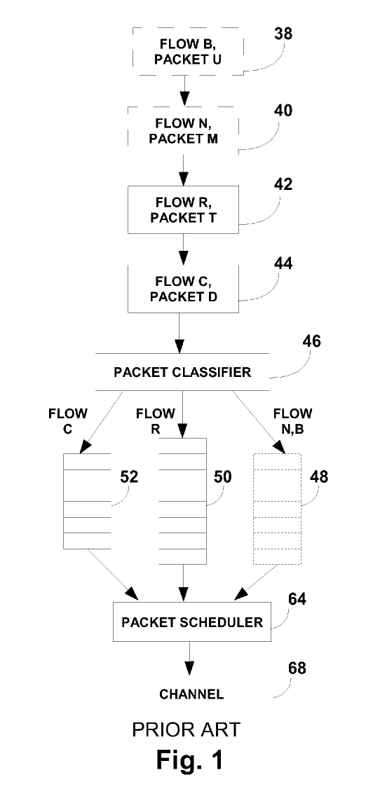

### DETAILED DESCRIPTION OF THE PRESENT INVENTION

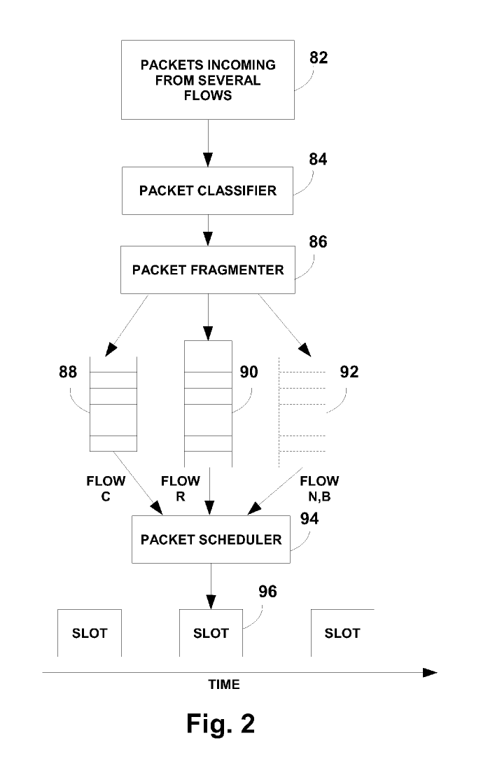

The invention is implemented in a computer network or in a communications network in which nodes receive packets and are to send packets on a slotted communications channel. Each packet to be sent is associated with a specific priority value. Multiple packets can be sent in each time slot (TS). The slot size is either constant or variable, but it is known in advance. To explain the invention reference is first made to FIG. 2, showing a schematic queue management of an exemplary arrangement of outgoing queues and feed system. Incoming packets 82, are of various flows converging into the node. In the node, packet classifier 84 classifies the packets and assigns them to specific queues. Some classified packets are processed by packet fragmenter 86. Each fragment is encapsulated to facilitate further routing. The fragments are then assigned to the respective queues. The packets are thus segregated in queues according to the existing flows. Queue 88 is populated by flow C packets, queue 90 by flow R packets, and queue 92 by flow N,B packets, and so on. Packet scheduler 94 is a module that populates the slots, such as slot 96 successively,

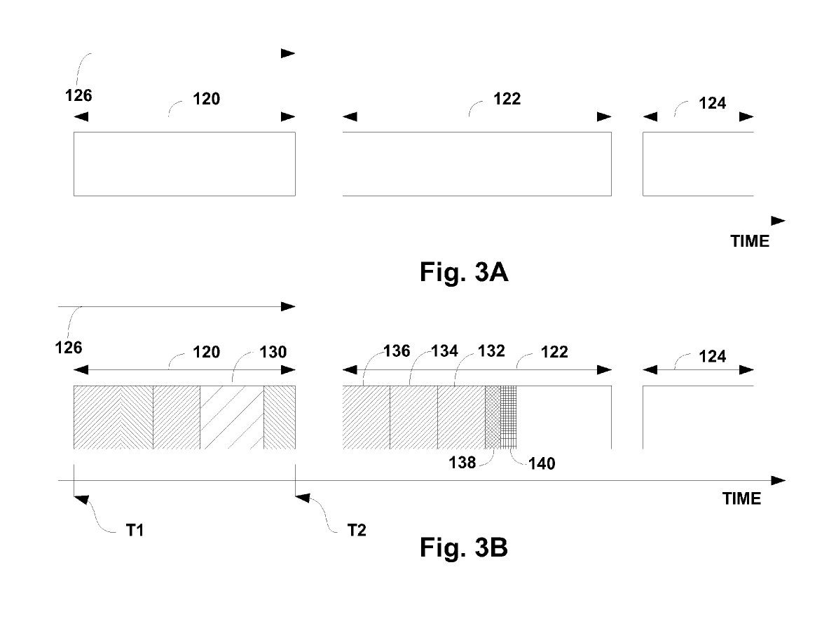

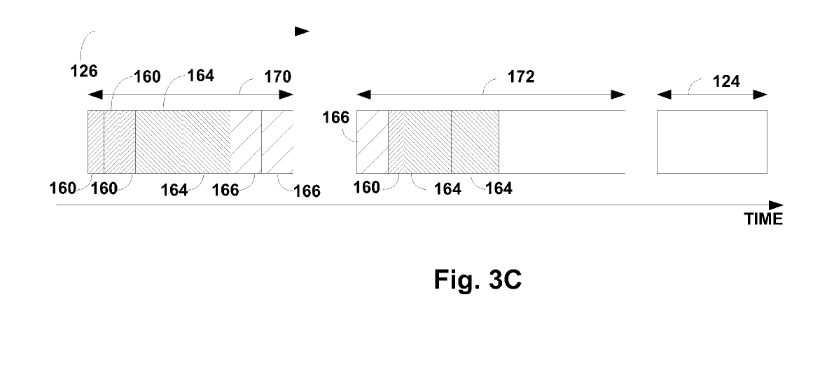

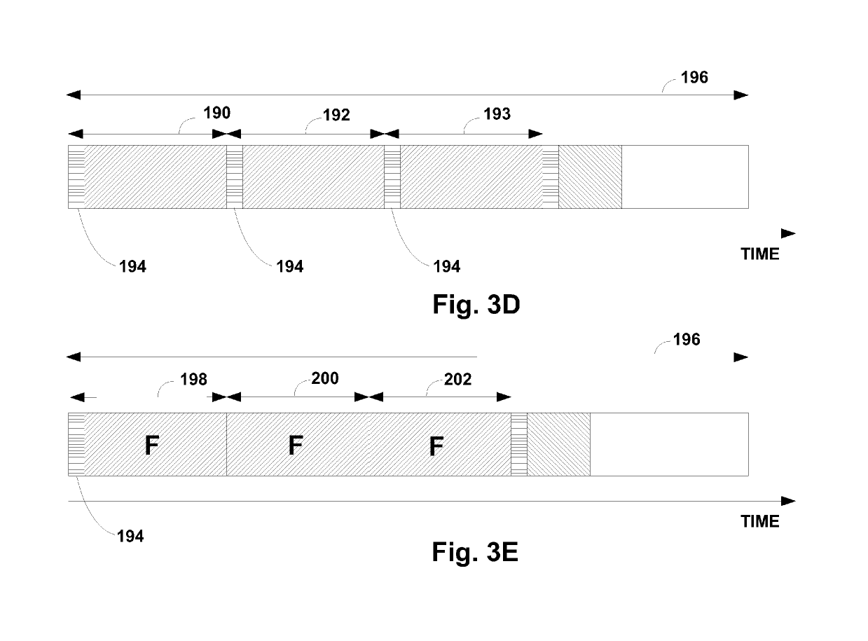

In FIG. 3A, a symbolic description of a succession of slots in a schematic slotted TDMA channel in which the invention is implemented shows various sizes of slots. Slot 120 is smaller in size (duration) than TS 122 and slot 124 is also smaller than slots 120 and 122. Arrows 126 denote the direction of populating sequence of the respective slot with packets.

In FIG. 3B, slot 120 is shown populated symbolically with packets, wherein each such symbolic packet is a hatched quadrangle. Packet 130 is the largest of the packets in the TS, i.e. the largest packet in the period of time between T1 and T2. Slot 122 is shown populated with three fragments of a large packet. Fragments 132, 134 and 136 all belonging originally to the same packet occupy the lower part of slot 122. Fragment 138 of a packet and fragment 140 of a different packet occupy the same time interval of slot 122.

In accordance with the invention, a queue order list (QOL) is defined, which determines the order in which each queue is served by the packet scheduler. The QOL is schematically described as a string of integers. Each integer refers to specific queue, and repetitions are allowed. The length of the string is a parameter dictated by the system. By distributing the service in each service cycle starvation can be prevented, meaning the phenomenon in which a flow receives lesser service than anticipated by the QoS weight. As described schematically in FIG. 3C, the QOL reads as follows (QoS types designated by letter): ABCAB. In this case 3 packets 160 of QoS A are populated in the direction of arrow 126. Then QoS B is served by populating 2 packets in a TS in sequence, namely packets 164 in TS 170. Then, 3 packets 166 of QoS C are populated, two in TS 170 and one in TS 172. QoS A is again served in the same cycle of service allowing only 1 packet 160 at this time, and QoS B is served again also in this cycle of service, allowing two packets 164 to populate in TS 172. As determined by the QOL, the weight of each flow referred to as “total quantum” (typically determined in bits) can be distributed in the form of partial quantums.

The longer the QOL, the more partial quantums can be assigned to one flow in each service cycle. The packet scheduler refers to the QOL cyclically to determine which queue to send to a node at a successive time slot. The accumulated quantum dictates the maximum bits that a selected queue can send in the successive time slot. Queues that were not permitted to send a packet in the previous time slot as a result of partial quantum lower than the packet's (at the head of the queue) size will have the privilege to send the remainder of the partial quantum in the successive time slots and the accumulated quantum will count the portions of partial quantum that have not been sent.

In the system in which the invention is implemented both TSs and packets are not necessarily uniform in size. Implementing the invention permits more efficient utilization of the bandwidth by fragmenting packets into smaller sized packet fragments (PFs), and multiplexing the PFs together with smaller packets in the same TSs. The packet to be fragmented is not necessarily larger in size then the respective TSs. The fragmentation of smaller-than-TS-packets also allows populating a larger proportion of the otherwise vacant time period. Packet fragmentation comes at a cost. As described schematically in FIG. 3D, as each fragment 190, 192, 193 is encapsulated, the relative overhead 194 of the entire packet in bits becomes larger as the packet is more highly fragmented. To overcome this drawback, in some embodiments of the invention, fragments of the same packet are populated as much as possible in the same time slot (TS) 196, as described schematically in FIG. 3E to which reference is now made. Fragments of the same packet 198, 200, 202 are populated consecutively in slot 196. The inclusion of the fragments in the same TS enables the reduction of the overhead in each of the fragments deployed in the same TS. Population of the same slots with fragments of the same packet is recommended also in the case of ad-hoc networks, in which the nodes are highly mobile. Routing a fragmented packet to the end point may not be accomplishable if long time periods are too long between fragments.

1. A method for servicing a multiplicity of different queues in a node of a network, wherein packets are sent over a time slotted communications channel, and wherein quality of service (QoS) is to be observed for each different queue, said method comprising:
classifying incoming packets to different QoS;
fragmenting at least some of the incoming packets into fragments;
assigning at least all said fragments to respective queues;
populating said incoming packets in TSs, in an order determined by a queue order list (QOL).

2. A method for servicing a multiplicity of different queues in a node of a network as in claim 1 and wherein said nonfragmented packets are assigned to respective queues.

3. A method for servicing a multiplicity of different queues in a node of a network as in claim 1 and wherein said QOL determines the relative weights for each queue served in each service cycle.

4. A method for servicing a multiplicity of different queues in a node of a network as in claim 1 and wherein fragments of the same packet are assigned to the same time slot to reduce packet fragment overhead.

5. A method for servicing a multiplicity of different queues in a node of a network as in claim 1 and wherein said QOL determines the number of times each queue is served in each service cycle.

6. A method for servicing a multiplicity of different queues in a node of a network as in claim 1 and wherein said QOL determines the order in which each queue is served in each service cycle.

7. An ad hoc communications network employing multi-hop routing, wherein each node employs an omnidirectional send/receive capability and keeps a near neighbour database (NND) updated by receiving of messages, wherein each Othernode the message of which was received by Mynode in a time period T, is a candidate for becoming a relay for transmitting Mynode's messages, and wherein the probability of an Othernode to become a relay for Mynode is higher for a larger amount of candidates said Othernode has in its NND, and the probability for said Othernode to become a relay is higher the larger its distance from Mynode.

8. An ad hoc communications network as in claim 1, wherein said NND is updated using at least maintenance messages sent periodically by each node.

9. An ad hoc communications network as in claim 1 wherein the bandwidth available is limited.
